(19) United States
(12) Patent Application Publication
(10) Pub. No.: US 2016/0209616 A1
(43) Pub. Date: Jul. 21, 2016

(54) ROADWAY EXPANSION JOINT FOR FIBER OPTIC CABLE DEPLOYMENT

(71) Applicant: Corning Optical Communications LLC, Hickory, NC (US)

(72) Inventor: Allen Michael Miller, Lenoir, NC (US)

(21) Appl. No.: 14/996,358

(22) Filed: Jan. 15, 2016

Related U.S. Application Data
(60) Provisional application No. 62/105,015, filed on Jan. 19, 2015.

(51) Int. Cl. G02B 6/50; E01C 23/02; E01C 11/22; E02F 5/12; E01C 7/18

(52) U.S. Cl. CPC G02B 6/504; E02F 5/12; E01C 7/182; E01C 11/22; E01C 23/025

(57) ABSTRACT

A modified expansion/construction joint and a method of forming the joint are disclosed, wherein all or a portion of a non-structural expansion/construction joint is widened through a sawing or other cutting process, a cable is placed in the resulting microtrench or on a bottom fill or backer material followed by top fill or backer material, and the microtrench is then sealed with a conventional crack sealer.

### CROSS-REFERENCE TO RELATED APPLICATIONS

This application claims the benefit of priority to U.S. Provisional Application No. 62/105,015, filed on Jan. 19, 2015, and is incorporated herein by reference.

### BACKGROUND

Aspects of the present disclosure relate generally to fiber optic cables and, in particular, to an expansion joint for deployment of fiber optic cables in roadways.

### SUMMARY

A modified expansion/construction joint and a method of forming the joint are disclosed, wherein all or a portion of a non-structural expansion/construction joint is widened through a sawing or other cutting process, a cable is placed in the resulting microtrench or on a bottom fill or backer material followed by top fill or backer material, and the microtrench is then sealed with a conventional crack sealer.

In accordance with yet other aspects of the present disclosure, an assembly for decoupling a cable from a roadway surface includes a microtrench defined by a widened expansion joint between a roadway surface and a curb or gutter, the expansion joint being widened only in the vicinity of the microtrench, a bottom fill material and a top fill material surrounding the cable positioned in the microtrench so as not to be in contact with the roadway surface, and a sealant material filling a remainder of the microtrench and providing a water-tight barrier between the roadway surface and the cable.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE FIGURES

The accompanying Figures are included to provide a further understanding, and are incorporated in and constitute a part of this specification. The drawings illustrate one or more embodiments, and together with the Detailed Description serve to explain principles and operations of the various embodiments. As such, the disclosure will become more fully understood from the following Detailed Description, taken in conjunction with the accompanying Figures, in which:

FIG. 1 illustrates a conventional asphalt roadway section with curb and gutter, in accordance with various aspects of the present disclosure.

FIG. 2 illustrates a modified expansion/construction joint incorporating a microtrench, in accordance with various aspects of the present disclosure.

### DETAILED DESCRIPTION

Before turning to the Figures, which illustrate exemplary embodiments in detail, it should be understood that the present inventive and innovative technology is not limited to the details or methodology set forth in the Detailed Description or illustrated in the Figures. For example, as will be understood by those of ordinary skill in the art, features and attributes associated with embodiments shown in one of the Figures may be applied to embodiments shown in others of the Figures.

Aspects of the present disclosure are directed to the deployment of fiber optic cables in roadways. In particular, existing expansion/construction joints between the roadway and the curb/gutter are present in at least 60% to 85% of the deployment paths in typical residential neighborhoods. Because these joints are non-structural, no repair or structural bonding material, such as polyurea, is necessary after installing fiber optic cables in the joints in accordance with aspects of the present disclosure, significantly reducing installation time and material cost.

Eliminating the conventional structural bonding material at 60% to 85% (100% if non-structural repair is approved) of the network length significantly reduces material cost and time to install the system. Cables placed in the expansion/construction joint between the asphalt roadway and the curb/gutter will experience less strain and signal loss because the cable is decoupled from the roadway. Conventionally deployed cables, where the cable is highly coupled to the roadway, experience strain as the roadway expands and contracts from temperature changes and more importantly, as the roadway locally displaces at defects such as crack, heaves and buckles.

A fiber optic cable installed in accordance with aspects of this disclosure may be easily extracted from the expansion/construction joint because it is surrounded by loose filler material or backer rods rather than structural bonding material, such as polyurea, that may be used with conventionally deployed roadway cables.

Aspects of the present disclosure involve forming a cable microtrench by cutting the expansion joint between the roadway and curb/gutter to an appropriate width and depth, placing the fiber optic cable in the microtrench, partially filling the trench with backer or other suitable filler material, and filling the remainder of the microtrench with conventional roadway crack sealer until flush with the roadway surface.

Because the cable may be required to traverse the roadway at intersections and laterally to each pair of residences, conventional deployment may be required over 15% to 40% of the network length where required by local municipalities. However, installation of cables in accordance with aspects of this disclosure may be used for lateral cuts and intersections in municipalities that approve use of non-structural microtrench closure techniques such as those for routed crack repair at cold joints and cracks in asphalt (see, e.g., Federal Highway Administration Report No. FHWA-RD-99-147, Materials and Procedures for Sealing and Filling Cracks in Asphalt-Surfaced Pavements, Sections 2.4 and 3.0, and Research Project 0-4061-P3 Comparison of Hot-Poured Crack Sealant to Emulsified Asphalt Crack Sealant, Field Manual for Crack Sealing Asphalt Pavements, Table 1 and Page 5, The University of Texas at Austin, Center for Transportation Research, Dr. Yetkin Yildirim, P.E., Ahmed Qatan, and Jorge Prozzi, Ph.D., January 2006.

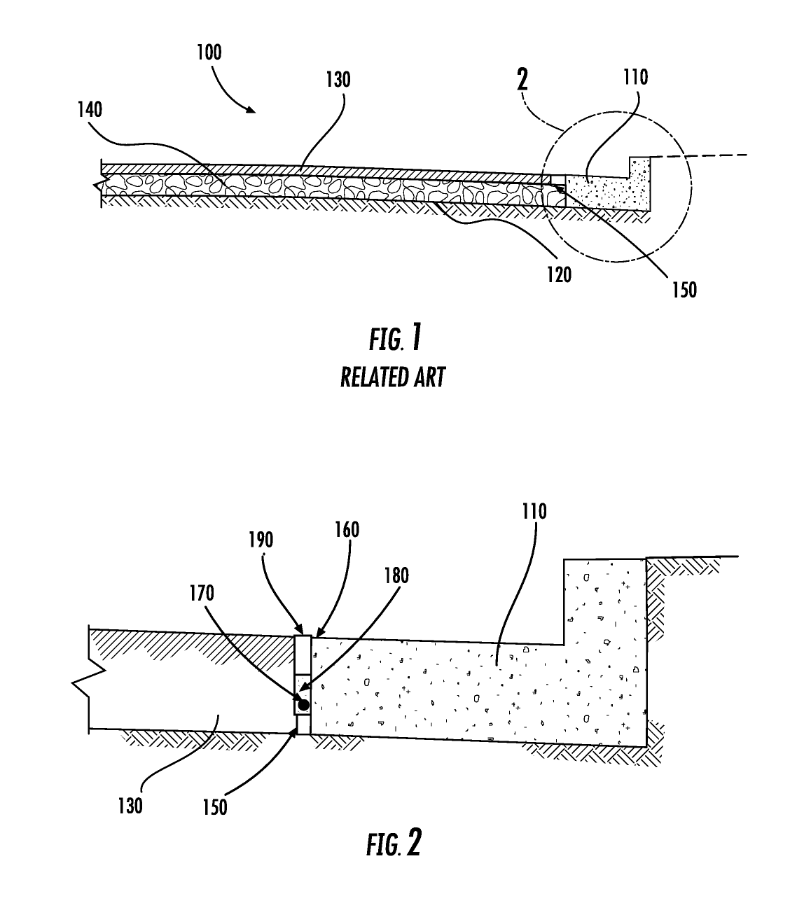

FIG. 1 shows a typical asphalt roadway section 100 with a curb/gutter 110. The roadway section 100 may be installed over a compacted subgrade 120 and include an asphalt roadway surface 130 installed over a crushed rock base 140. As shown in FIG. 1, a non-structural expansion/construction joint 150 may be provided between the asphalt and the curb/gutter to accommodate roadway expansion and contraction due to temperature cycling, for example.

Expansion/construction joints exist between the asphalt (or concrete) roadway and the gutter/curb in roadway design. An expansion/construction joint is a non-structural joint between roadway components that are constructed at different times and generally made of different materials. In accordance with aspects of this disclosure, all or a portion of the expansion/construction joint 150 may be widened and/or cut to a predetermined depth to form a microtrench 160 through a sawing or other cutting process. The width between the two vertically extending walls of the microtrench 160 may be, for example, approximately 1-12 cm, preferably 4-12 cm. A cable 170, such as fiber optic cable of the type made by Corning Optical Communications, Inc., may be placed in the microtrench 160 or on a bottom fill or backer material followed by top fill or backer material 180. The cable 170 may be a fiber optic cable of the type normally used for outdoor or exterior installation, comprising one or more optical fibers encapsulated in an exterior sheath, which may be a polymeric outer jacket and/or a metal jacket, sheath or tube, for example. An external diameter of the cable 170 may be in the range of 3-10 mm, for example. The microtrench 160 may then be sealed with a conventional crack sealer, which may be any suitable sealing material 190 or bitumen, for example.

Decoupling the cable 170 from the roadway surface 130 by forming a microtrench 160 from the expansion/construction joint and placing the cable 170 into the microtrench 160 also provides for increased reliability of the cable. The microtrench 160 may be formed such that any forces generated by the temperature cycling and/or local displacement of the roadway surface 130 are substantially absorbed by the backer material 180 and/or the sealing material 190 rather than the cable 170.

Moreover, the widening of the expansion/construction joint 150 and placing the cable 170, fill or backer material 180, and sealing material 190 does not affect the integrity of the roadway surface 130. In fact, the integrity of the roadway surface is improved because the sealing material 190 inhibits water from entering the microtrench 160 and expanding in cold climates.

Municipalities that accept non-structural configurations, such as the configuration illustrated in FIG. 2, will permit use of this invention over the entire network build, thereby significantly lowering cost and improving serviceability of the network. Municipalities that require structural repair of microtrenches at intersections and lateral cut after cables are placed, will permit use of this invention over 60% to 85% of the entire network path which lowers cost and improves serviceability of a majority of the network. According to aspects of the present disclosure, the cable 170 may be easily removed from the microtrench 160 by removal of the sealing material 190 from the expansion joint 150 without having to further cut into the roadway surface.

The construction and arrangements of the expansion/construction joint and microtrench, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive and innovative technology.

What is claimed is:

1. A method of deploying a cable, comprising:
forming a microtrench by cutting an expansion joint provided between a roadway surface and a curb or a gutter to a predetermined width and predetermined depth;
placing the cable in the microtrench; and
sealing the microtrench with a crack sealer until the crack sealer is flush with the roadway surface.

2. The method of claim 1, wherein the cable is decoupled from the roadway surface via the expansion joint.

3. The method of claim 1, further comprising:
partially filling the microtrench with a bottom fill material prior to placing the cable.

4. The method of claim 3, further comprising:
partially filling the microtrench with a top fill material after placing the cable.

5. The method of claim 3, wherein the bottom fill material is crushed rock.

6. The method of claim 4, further comprising forming the microtrench such that forces generated by temperature cycling or displacement of the roadway surface are substantially absorbed by the top fill material and the bottom fill material.

7. The method of claim 1, wherein the cable is an optical fiber cable.

8. An assembly for decoupling a cable from a roadway surface, the assembly comprising:
a microtrench defined by a widened expansion joint between a roadway surface and a curb or gutter, the expansion joint being widened only in the vicinity of the microtrench;
a bottom fill material and a top fill material surrounding the cable positioned in the microtrench so as not to be in contact with the roadway surface; and
a sealant material filling a remainder of the microtrench and providing a water-tight barrier between the roadway surface and the cable.

9. The assembly of claim 8, wherein the sealant material is a bitumen material.

10. The assembly of claim 8, wherein the sealant material is flush with the roadway surface.
